(19) United States
(12) Patent Application Publication
(10) Pub. No.: US 2023/0237320 A1
(43) Pub. Date: Jul. 27, 2023

(54) NEURAL NETWORK PROCESSING METHOD AND DEVICE THEREFOR

(71) Applicant: FURIOSAAI INC., Seoul (KR)

(72) Inventors: Hanjoon KIM, Hwaseong-si (KR); Byung Chul HONG, Seongnam-si (KR)

(73) Assignee: FURIOSAAI INC., Seoul (KR)

(21) Appl. No.: 18/007,962

(22) PCT Filed: Jun. 7, 2021
(86) PCT No.: PCT/KR2021/007059

§ 371 Date: Dec. 2, 2022

(30) Foreign Application Priority Data
Jun. 5, 2020 (KR) 10-2020-0068572

(51) Int. Cl. G06N 3/063

(52) U.S. Cl. CPC G06N 3/063

(57) ABSTRACT

A device for ANN processing according to an embodiment of the present invention comprises: a first processing element (PE) comprising a first operation unit and a first controller for controlling the first operation unit; and a second PE comprising a second operation unit and a second controller for controlling the second operation unit, wherein the first PE and the second PE are reconfigured into a single fused PE for parallel processing with respect to a specific ANN model, operators comprised in the first operation unit and operators comprised in the second operation unit in the fused PE establish a data network controlled by means of the first controller, and control signal transmitted from the first controller can reach respective operators via a control transmission path different from a data transmission path of the data network.

### TECHNICAL FIELD

The present invention relates to a neural network, and more particularly, to an artificial neural network (ANN)-related processing method and a device for performing the same.

### BACKGROUND ART

Neurons constituting the human brain form a kind of signal circuit, and a data processing architecture and method that mimic the signal circuit of neurons is called an artificial neural network (ANN). In an ANN, a number of interconnected neurons forms a network, and an input/output process for individual neurons can be mathematically modeled as [Output=f(W1×Input 1+W2×Input 2+ . . . +WN×Input N]). Wi represents a weight, and the weight may have various values depending on the ANN type/model, layers, each neuron, and learning results.

With the recent development of computing technology, a deep neural network (DNN) having a plurality of hidden layers among ANNs is being actively studied in various fields, and deep learning is a training process (e.g., weight adjustment) in a DNN. Inference refers to a process of obtaining an output by inputting new data into a trained neural network (NN) model.

A convolutional neural network (CNN) is one of representative DNNs and may be configured based on a convolutional layer, a pooling layer, a fully connected layer, and/or a combination thereof The CNN has a structure suitable for learning two-dimensional data and is known to exhibit excellent performance in image classification and detection.

Since massive layers, data, and memory read/write are involved in operations for training or inference of NNs including CNNs, distributed/parallel processing, a memory structure, and control thereof are key factors that determine performance.

### DISCLOSURE

### Technical Task

A technical task of the present invention is to provide a more efficient neural network processing method and a device therefor.

In addition to the aforementioned technical task, other technical tasks may be inferred from the detailed description.

### Technical Solutions

A device for artificial neural network (ANN) processing according to an aspect of the present invention includes a first processing element (PE) comprising a first operation unit and a first controller configured to control the first operation unit, and a second PE comprising a second operation unit and a second controller configured to control the second operation unit, wherein the first PE and the second PE are reconfigured into one fused PE for parallel processing for a specific ANN model, operators included in the first operation unit and operators included in the second operation unit form a data network controlled by the first controller in the fused PE, and a control signal transmitted from the first controller arrives at each operator through a control transfer path different from a data transfer path of the data network.

The data transfer path may have a linear structure and the control transfer path may have a tree structure.

The control transfer path may have a lower latency than the data transfer path.

The second controller in the fused PE may be disabled in the fused PE.

An output by a last operator of the first operation unit may be applied as an input of a leading operator of the second operation unit in the fused PE.

The operators included in the first operation unit and the operators included in the second operation unit may be segmented into a plurality of segments in the fused PE, and the control signal transmitted from the first controller may arrive at the plurality of segments in parallel.

The first PE and the second PE may perform processing on a second ANN model and a third ANN model different from the specific ANN model independently of each other.

The specific ANN model may be a pre-trained deep neural network (DNN) model.

The device may be an accelerator configured to perform inference based on the DNN model.

An artificial neural network (ANN) processing method according to another aspect of the present invention includes reconfiguring a first processing element (PE) and a second PE into one fused PE for processing for a specific ANN model, and performing processing for the specific ANN model in parallel through the fused PE, wherein the reconstructing the first PE and the second PE into the fused PE comprises forming a data network through operators included in the first PE and operators included in the second PE, the processing for the specific model comprises controlling a data network through a control signal from a controller of the first PE, and a control transfer path for the control signal is set to be different from a data transfer path of the data network.

A processor-readable recording medium storing instructions for performing the above-described method may be provided according to another aspect of the present invention.

### Advantageous Effects

According to an embodiment of the present invention, since the processing method and device are reconfigured adaptively to the corresponding ANN model, processing for the ANN model can be performed more efficiently and rapidly.

Other technical effects of the present invention can be inferred from the detailed description.

### DESCRIPTION OF DRAWINGS

FIG. 1 shows an example of a system according to an embodiment of the present invention.

FIG. 2 shows an example of a PE according to an embodiment of the present invention.

FIGS. 3 and 4 show devices for processing according to an embodiment of the present invention.

FIG. 5 shows an example for describing a relationship between an operation unit size and throughput along with ANN models.

FIG. 6 illustrates a data path and a control path when PE fusion is used according to an embodiment of the present invention.

FIG. 7 illustrates various PE configuration/execution examples according to an embodiment of the present invention.

FIG. 8 shows an example for describing PE independent execution and PE fusion according to an embodiment of the present invention.

FIG. 9 is a diagram for describing a flow of an ANN processing method according to an embodiment of the present invention.

### MODE FOR INVENTION

Hereinafter, exemplary embodiments applicable to a method and device for neural network processing will be described. The examples described below are non-limiting examples for aiding in understanding of the present invention described above, and it can be understood by those skilled in the art that combinations/omissions/changes of some embodiments are possible.

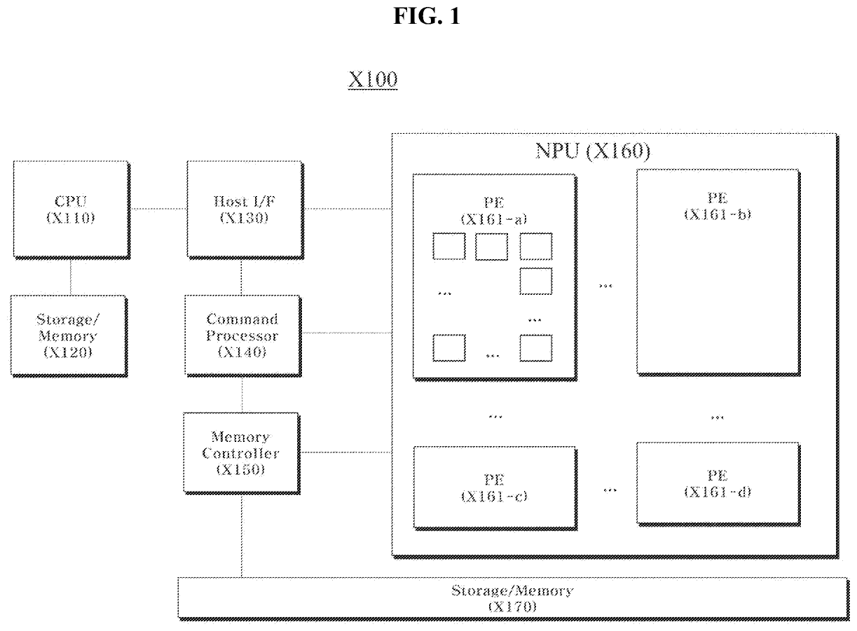

FIG. 1 shows an example of a system including an operation processing unit (or processor).

Referring to FIG. 1, a neural network processing system X100 according to the present embodiment may include at least one of a central processing unit (CPU) X110 and a neural processing unit (NPU) X160.

The CPU X110 may be configured to perform a host role and function to issue various commands to other components in the system, including the NPU X160. The CPU X110 may be connected to a storage/memory X120 or may have a separate storage provided therein. The CPU X110 may be referred to as a host and the storage X120 connected to the CPU X110 may be referred to as a host memory depending on the functions executed thereby.

The NPU X160 may be configured to receive a command from the CPU X110 to perform a specific function such as an operation. In addition, the NPU X160 includes at least one processing element (PE, or processing engine) X161 configured to perform ANN-related processing. For example, the NPU X160 may include 4 to 4096 PEs X161 but is not necessarily limited thereto. The NPU X160 may include less than 4 or more than 4096 PEs X161.

The NPU X160 may also be connected to a storage X170 and/or may have a separate storage provided therein.

The storages X120 and 170 may be a DRAM/SRAM and/or NAND, or a combination of at least one thereof, but are not limited thereto, and may be implemented in any form as long as they are a type of storage for storing data.

Referring back to FIG. 1, the neural network processing system X100 may further include a host interface (Host IN) X130, a command processor X140, and a memory controller X150.

The host interface X130 is configured to connect the CPU X110 and the NPU X160 and allows communication between the CPU X110 and the NPU X160 to be performed.

The command processor X140 is configured to receive a command from the CPU X110 through the host interface X130 and transmit it to the NPU X160.

The memory controller X150 is configured to control data transmission and data storage of each of the CPU X110 and the NPU X160 or therebetween. For example, the memory controller X150 may control operation results of the PE X161 to be stored in the storage X170 of the NPU X160.

Specifically, the host interface X130 may include a control/status register. The host interface X130 provides an interface capable of providing status information of the NPU X160 to the CPU X110 and transmitting a command to the command processor X140 using the control/status register. For example, the host interface X130 may generate a PCIe packet for transmitting data to the CPU X110 and transmit the same to a destination or may transmit a packet received from the CPU X110 to a designated place.

The host interface X130 may include a direct memory access (DMA) engine to transmit massive packets without intervention of the CPU X110. In addition, the host interface X130 may read a large amount of data from the storage X120 or transmit data to the storage X120 at the request of the command processor X140.

Further, the host interface X130 may include a control/status register accessible through a PCIe interface. In a system booting process according to the present embodiment, physical addresses of the system (PCIe enumeration) are allocated to the host interface X130. The host interface X130 may read or write to the space of a register by executing functions such as loading and storing in the control/status register through some of the allocated physical addresses. State information of the host interface X130, the command processor X140, the memory controller X150, and the NPU X160 may be stored in registers of the host interface X130.

Although the memory controller X150 is positioned between the CPU X110 and the NPU X160 in FIG. 1, this is not necessarily limited thereto. For example, the CPU X110 and the NPU X160 may have different memory controllers or may be connected to separate memory controllers.

In the above-described neural network processing system X100, a specific operation such as image determination may be described in software and stored in the storage X120 and may be executed by the CPU X110. The CPU X110 may load weights of a neural network from a separate storage device (HDD, SSD, etc.) to the storage X120 in a process of executing a program, and load the same to the storage X170 of the NPU X160. Similarly, the CPU X110 may read image data from a separate storage device, load the same to the storage X120, perform some conversion processes, and then store the same in the storage X170 of the NPU X160.

Thereafter, the CPU X110 may instruct the NPU X160 to read the weights and the image data from the storage X170 of the NPU X160 and perform an inference process of deep learning. Each PE X161 of the NPU X160 may perform processing according to an instruction of the CPU X110. After the inference process is completed, the result may be stored in the storage X170. The CPU X110 may instruct the command processor X140 to transmit the result from the storage X170 to the storage X120 and finally transmit the result to software used by the user.

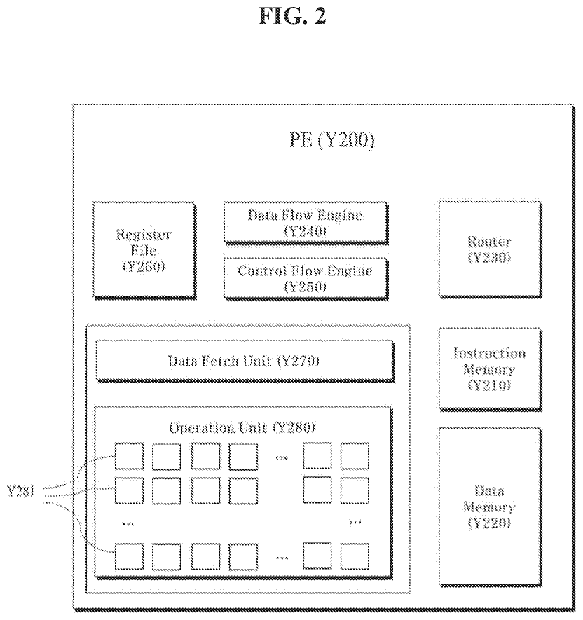

FIG. 2 shows an example of a detailed configuration of a PE.

Referring to FIG. 2, a PE Y200 according to the present embodiment may include at least one of an instruction memory Y210, a data memory Y220, a data flow engine Y240, a control flow engine 250 or an operation unit Y280. In addition, the PE Y200 may further include a router Y230, a register file Y260, and/or a data fetch unit Y270.

The instruction memory Y210 is configured to store one or more tasks. A task may be composed of one or more instructions. An instruction may be code in the form of an instruction but is not necessarily limited thereto. Instructions may be stored in a storage associated with the NPU, a storage provided inside the NPU, and a storage associated with the CPU.

The task described in this specification means an execution unit of a program executed in the PE Y200, and the instruction is an element formed in the form of a computer instruction and constituting a task. One node in an artificial neural network performs a complex operation such as f(Σwi×xi), and this operation can be performed by being divided by several tasks. For example, all operations performed by one node in an artificial neural network may be performed through one task, or operations performed by multiple nodes in an artificial neural network may be performed through one task. Further, commands for performing operations as described above may be configured as instructions.

For convenience of understanding, a case in which a task is composed of a plurality of instructions and each instruction is composed of code in the form of a computer instruction is taken as an example. In this example, the data flow engine Y240 described below checks completion of data preparation of tasks for which data necessary for each execution is prepared. Thereafter, the data flow engine 240 transmits task indexes to a fetch ready queue in the order in which data preparation is completed (starts execution of the tasks) and sequentially transmits the task indexes to the fetch ready queue, a fetch block, and a running ready queue. In addition, a program counter Y252 of the control flow engine Y250 described below sequentially executes a plurality of instructions included in the tasks to analyze the code of each instruction, and thus the operation in the operation unit Y280 is performed. In this specification, such processes are represented as “executing a task.” In addition, the data flow engine Y240 performs procedures such as “checking data,” “loading data,” “instructing the control flow engine to execute a task,” “starting execution of a task,” and “performing task execution,” and processes according to the control flow engine Y250 are represented as “controlling execution of tasks” or “executing task instructions.” In addition, a mathematical operation according to the code analyzed by the program counter 252 may be performed by the following operation unit Y280, and the operation performed by the operation unit Y280 is referred to herein as “operation.” The operation unit Y280 may perform, for example, a tensor operation. The operation unit Y280 may also be referred to as a functional unit (FU).

The data memory Y220 is configured to store data associated with tasks. Here, the data associated with the tasks may be input data, output data, weights, or activations used for execution of the tasks or operation according to execution of the tasks, but is not necessarily limited thereto.

The router Y230 is configured to perform communication between components constituting the neural network processing system and serves as a relay between the components constituting the neural network processing system. For example, the router Y230 may relay communication between PEs or between the command processor Y140 and the memory controller Y150. The router Y230 may be provided in the PE Y200 in the form of a network on chip (NOC).

The data flow engine Y240 is configured to check whether data is prepared for tasks, load data necessary to execute the tasks in the order of the tasks for which the data preparation is completed, and instruct the control flow engine Y250 to execute the tasks. The control flow engine Y250 is configured to control execution of the tasks in the order instructed by the data flow engine Y240. Further, the control flow engine Y250 may perform calculations such as addition, subtraction, multiplication, and division that occur as the instructions of tasks are executed.

The register file Y260 is a storage space frequently used by the PE Y200 and includes one or more registers used in the process of executing code by the PE Y200. For example, the register file 260 may be configured to include one or more registers that are storage spaces used as the data flow engine Y240 executes tasks and the control flow engine Y250 executes instructions.

The data fetch unit Y270 is configured to fetch operation target data according to one or more instructions executed by the control flow engine Y250 from the data memory Y220 to the operation unit Y280. Further, the data fetch unit Y270 may fetch the same or different operation target data to a plurality of operators Y281 included in the operation unit Y280.

The operation unit Y280 is configured to perform operations according to one or more instructions executed by the control flow engine Y250 and is configured to include one or more operators Y281 that perform actual operations. The operators Y281 are configured to perform mathematical operations such as addition, subtraction, multiplication, and multiply-and-accumulate (MAC). The operation unit Y280 may be of a form in which the operators Y281 are provided at a specific unit interval or in a specific pattern. When the operators Y281 are formed in an array form in this manner, the operators Y281 of an array type can perform operations in parallel to process operations such as complex matrix operations at once.

Although the operation unit Y280 is illustrated in a form separate from the control flow engine Y250 in FIG. 2, the PE Y200 may be implemented in a form in which the operation unit Y280 is included in the control flow engine Y250.

Result data according to an operation of the operation unit Y280 may be stored in the data memory Y220 by the control flow engine Y250. Here, the result data stored in the data memory Y220 may be used for processing of a PE different from the PE including the data memory. For example, result data according to an operation of the operation unit of a first PE may be stored in the data memory of the first PE, and the result data stored in the data memory of the first PE may be used in a second PE.

A data processing device and method in an artificial neural network and a computing device and method in an artificial neural network may be implemented by using the above-described neural network processing system and the PE Y200 included therein.

PE Fusion for ANN Processing

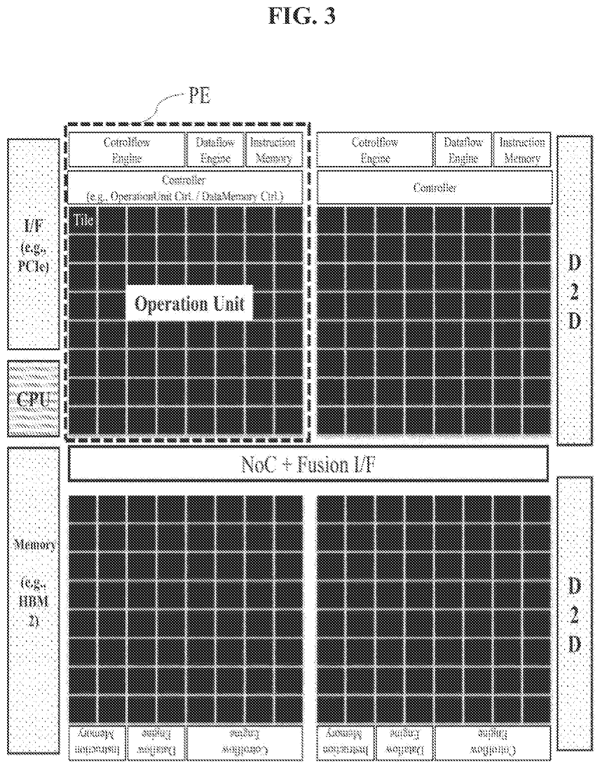

FIG. 3 illustrates a device for processing according to an embodiment of the present invention.

The device for processing shown in FIG. 3 may be, for example, a deep learning inference accelerator. The deep learning inference accelerator may refer to an accelerator that performs inference using a model trained through deep learning. The deep learning inference accelerator may be referred to as a deep learning accelerator, an inference accelerator, or an accelerator for short. For inference of the deep learning accelerator, a model trained in advance through deep learning is used, and such a model may be simply referred to as a “deep learning model” or a “model.”

Although the inference accelerator will be mainly described below for convenience, the inference accelerator is merely a form of a neural processing unit (NPU) or an ANN processing device including an NPU to which the present invention is applicable, and application of the present invention is not limited to the inference accelerator. For example, the present invention can also be applied to an NPU processor for learning/training.

When the unit for controlling an operation in an accelerator is referred to as a PE, one accelerator may be configured to include a plurality of PEs. In addition, the accelerator may include a network on chip interface (NoC I/F) that provides a mutual interface for the plurality of PEs. The NoC IN may provide I/F for PE fusion which will be described later.

The accelerator may include controllers such as a control flow engine, a CPU core, an operation unit controller, and a data memory controller. Operation units may be controlled through a controller.

An operation unit may be composed of a plurality of sub-operation units (e.g., operators such as MAC). A plurality of sub-operation units may be connected to each other to form a sub-operation unit network. The connection structure of the network may have various forms such as a line, a ring, and a mesh and may be extended to cover sub-operation units of a plurality of PEs. In the examples which will be described later, it is assumed that the network connection structure has a line form and can be extended to one additional channel, but this is for convenience of description and the scope of the present invention is not limited thereto.

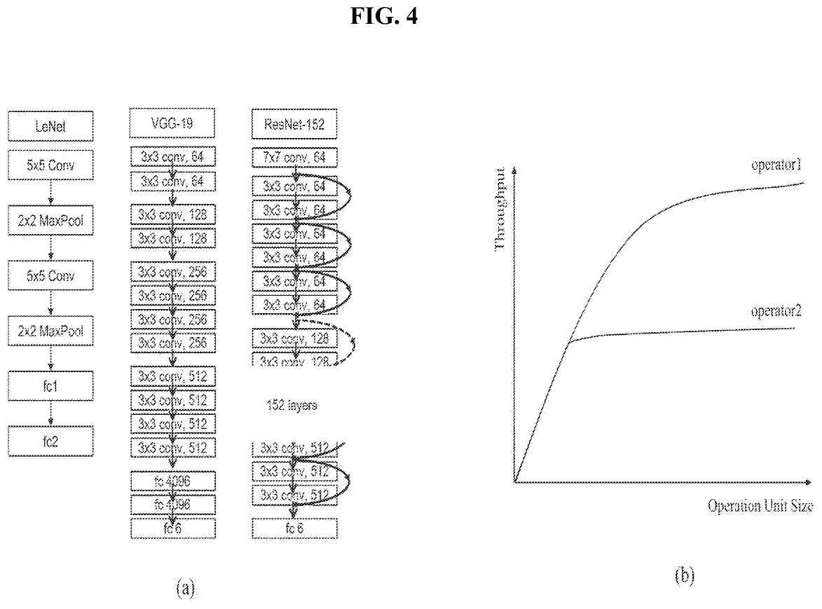

According to an embodiment of the present invention, the accelerator structure of FIG. 3 may be repeated within one processing device. For example, the processing device shown in FIG. 4 includes four accelerator modules. For example, the four accelerator modules may be aggregated to operate as one large accelerator. The number and aggregation form of accelerator modules aggregated for the extended structure as shown in FIG. 4 may be changed in various manners according to embodiments. FIG. 4 may be understood as an example of implementation of a multi-core processing device or a multi-core NPU.

Meanwhile, each of a plurality of PEs may independently execute inference, or one model may be processed through 1) data parallel method or 2) model parallel method depending on a deep learning model.

1) The data parallel method is the simplest parallel operation method. According to the data parallel method, a model (e.g., model weights) is equally loaded in PEs, but different input data (e.g., input activation) may be provided to the PEs.

2) The model parallel method may refer to a method in which one large model is distributed and processed over multiple PEs. When a model becomes larger than a certain level, it may be more efficient in terms of performance to divide the model into units each fitting one PE and process the same.

However, the application of the model parallel method in a more practical environment has the following difficulties. (i) When a model is divided and processed in units of operation layers in a pipelined parallel method, there is a problem that it is difficult to reduce the overall latency. For example, even if multiple PEs are used, only one PE is used at the time of processing one layer, and thus a latency identical to or greater than a latency required for processing with one PE is required. (ii) When multiple PEs divide and process each operation layer of a model in a tensor parallel method (e.g., one layer is assigned to N PEs), it is difficult to evenly distribute input activations and weights that are operation targets to the PEs in most cases. For example, to perform an operation on a fully connected layer, weights can be evenly distributed but input activations cannot be distributed, and all input activations are required in all PEs.

On the other hand, the use of a large size PE may have disadvantages in terms of cost effectiveness. A PE having a size greater than parallelism in the model has a low PE utilization (due to limitation of parallel processing).

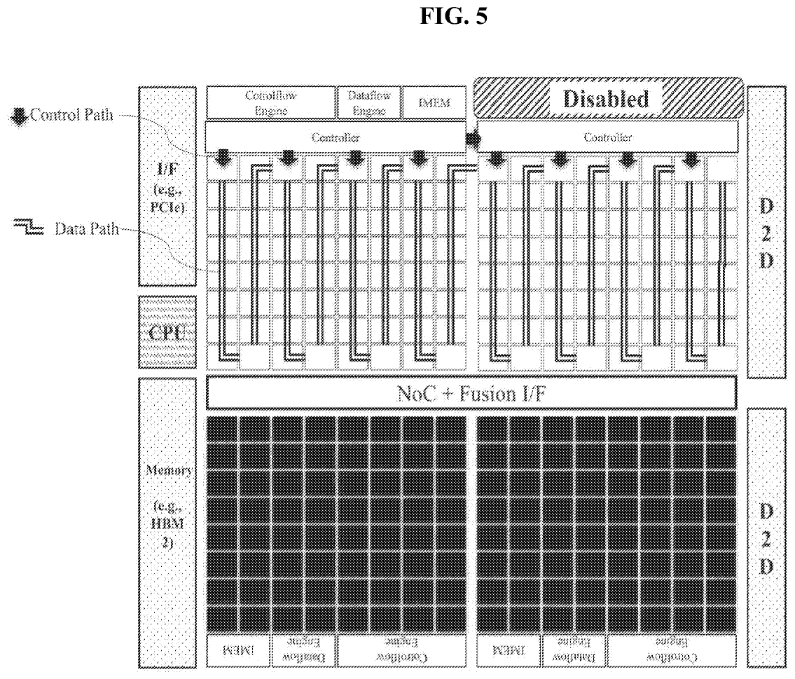

As an example of more specific (CNN) models, FIG. 5(a) shows LeNet, VGG-19, a nd ResNet-15 algorithms. According to the LeNet algorithm, operations are performed in the order of a first convolutional layer Conv1, a second convolutional layer Conv2, a third convolutional layer Conv3, a first fully connected layer fc1, and a second fully connected layer fc2. In fact, a deep learning algorithm includes a very large number of layers, but it can be understood by those skilled in the art that FIG. 5(a) illustrates the algorithms as briefly as possible for convenience of description. VGG-19 has 18 layers and ResNet-152 has a total of 152 layers.

FIG. 5(b) shows an example for describing a relationship between an operation unit size and throughput.

Operators constituting a model (e.g., operators obtained by compiling the code of the model corresponding to an algorithm) may have different operation characteristics.

Although performance may be improved proportionally even if the size of an operation unit increases depending on the operation characteristics of operators, in the case of an operator that has insufficient parallelism, even if the size of an operation unit increases, throughput may not be improved in proportion thereto.

Considering this point, a PE structure suitable/adaptive to the corresponding model is proposed. A method of configuring and controlling an appropriate PE structure depending on a model is proposed.

For example, when independent execution of individual PEs is effective, for example, if a model is small enough to fit one PE, and PE independent execution maximizes the utilization of PEs, individual PEs may be independently executed.

On the other hand, in a situation where a model is larger than a certain level and it is important to minimize the latency required for model operation, a plurality of individual PEs may be fused/reconstructed and executed as if they are a single (large) PE.

According to an embodiment of the present invention, a PE configuration may be determined based on characteristics of a model (or DNN characteristics).

For example, if a model is large (e.g., model size>PE SRAM size) and throughput can be improved by providing an operation unit larger than 1 PE (e.g., when throughput increases in proportion to the total operation capacity), fusion of a plurality of PEs can be enabled. Accordingly, latency can be reduced and throughput can be increased.

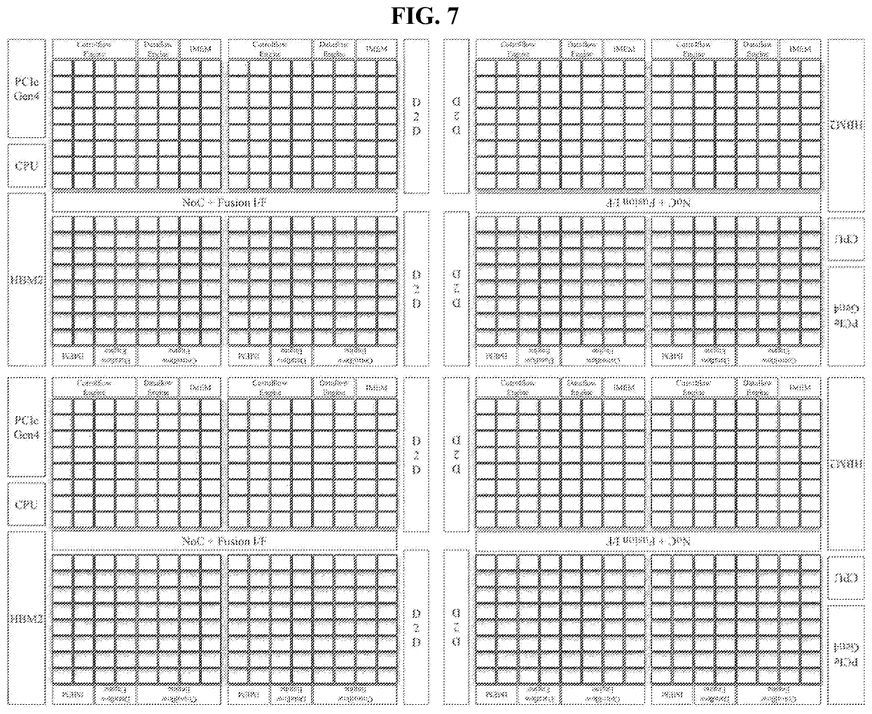

When a model is large but (substantial) throughput is not improved or is below a certain level for the model even if an operation unit larger than 1 PE is provided, one model may be divided into multiple parts (e.g., equal parts) and sequentially in multiple PEs (e.g., pipelining in FIG. 7(c)). In this case, throughput improvement of the entire system can be expected even if latency is not reduced.

When a model is small and (substantial) throughput is not improved or is below a certain level for the model even if an operation unit larger than 1 PE is provided, each PE may independently perform inference processing. In this case, throughput improvement of the overall system can be expected.

In the case of a tile-type accelerator with a linear topology (e.g., a two-dimensional array of serially connected tiles), PE fusion can be performed simply by connecting the last tile of the first PE with the first tile of the second PE.

Due to characteristics of the linear topology, latency may increase in control signal/command (hereinafter, “control”) transmission during PE fusion. For example, the length of a data path increases according to the number of fused PEs (or the total number of tiles included in fused PEs) during PE fusion, and if the control needs to be transmitted through the same path as the data path, there is a problem that PE fusion leads to increased control latency.

According to an embodiment of the present invention, a new control path for PE fusion is proposed. The control path may correspond to a network with a different topology from a data transmission network. For example, if PE fusion is enabled, a control path shorter than a data path may be used/configured.

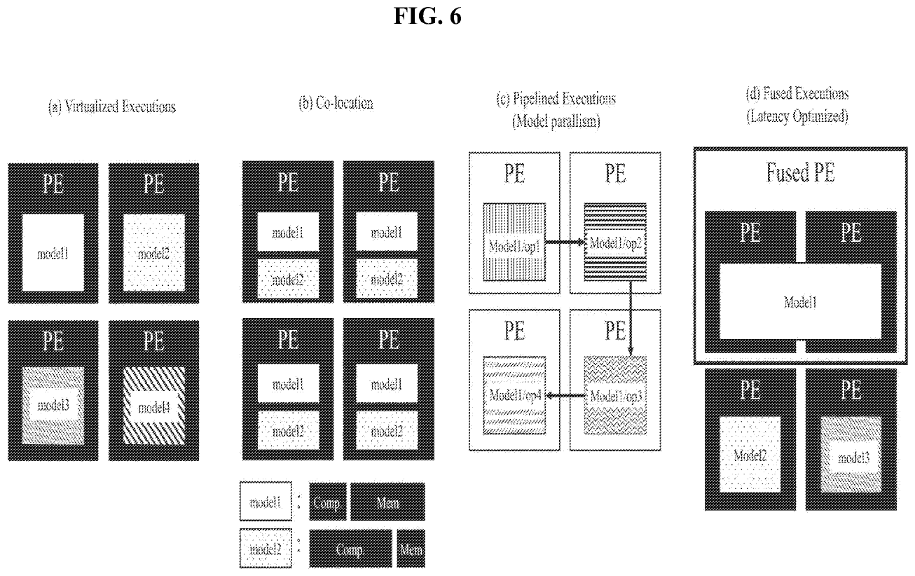

FIG. 6 illustrates a data path and a control path when PE fusion is used according to an embodiment of the present invention. Referring to FIG. 6, in the case of PE fusion, control may be transmitted through a path in a tree structure.

When PE fusion is used, a data path may be constructed along a serial connection of tiles and a control path may be constructed along a parallel connection of tree structures.

As an example of a tree structure, control may be transmitted substantially in parallel (or within a certain cycle) to tile segments (e.g., a tile group in a PE).

Operation units can perform operations in parallel based on the control transmitted to the tree structure.

FIG. 7 shows various PE configuration/execution examples according to an embodiment of the present invention.

FIG. 7(a) shows virtualized execution of each PE as one independent inference accelerator by a plurality of virtual machines. For example, different models and/or activations may be assigned to respective PEs, and execution and control of each PE may also be individually performed.

In FIG. 7(b), a plurality of models may be co-located in each PE and may be executed with time sharing. Since a plurality of models is allocated to the same PE and share resources (e.g., computing resources, memory resources, etc.), resource utilization can be improved.

FIG. 7(c) illustrates pipelining for parallel processing of the same model as mentioned above, and FIG. 7(d) illustrates the above-described fused PE scheme.

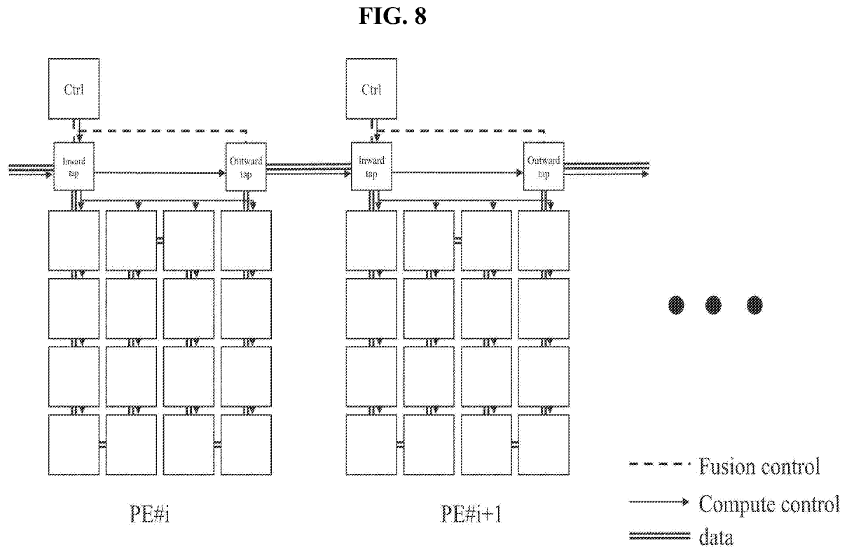

PE independent execution and PE fusion are described with reference to FIG. 8. Although PE#i and PE#i+1 are shown in FIG. 8, a total of N+1 PEs PE#0 to PE#N will be described.

[PE Independent Execution]

Each PE is set to a fusion disable state. Each PE receives (computes) control from the controller thereof Fusion enable/disable may be set through inward tap/outward tap of the corresponding PE. In the fusion disable state, inward/outward tap prevents data transmission to/from neighboring PEs. The inward tap may be used to set an input source of the corresponding PE. Depending on operation setting of the inward tap, output from the preceding PE (output from the preceding PE outward tap) may or may not be used as an input of the corresponding PE. The outward tap may be used to set an output destination of the corresponding PE. Depending on operation setting of the outward tap, output of the corresponding PE may or may not be transmitted to the subsequent PE.

The controller of each PE is enabled to control the corresponding PE.

[PE Fusion]

Inward/outward tap of each PE is set to a fusion enable state.

The controllers of PE#1 to PE#N are disabled. PE#0 receives (computes) control from the controller thereof (controller of PE#0 is enable). All other PEs receive control from inward taps. As a result, PE#0 to PE#N can operate as one (large) PE operated by the controller of PE#0.

PE#0 to PE#N-1 transmit data to the subsequent PEs through outward taps. PE#1 to PE#N receive data from the preceding PEs through inward taps.

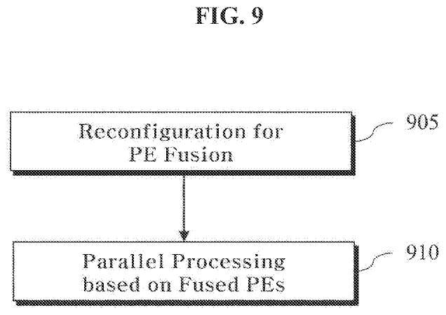

FIG. 9 shows a flow of a processing method according to an embodiment of the present invention. FIG. 9 shows an example of implementation of the above-described embodiments, and the present invention is not limited to the example of FIG. 9.

Referring to FIG. 9, a device for ANN processing (hereinafter, “device”) may reconfigure a first processing element (PE) and a second PE into one fused PE for processing for a specific ANN model (905). Reconfiguring the first PE and the second PE into the fused PE may include forming a data network through operators included in the first PE and operators included in the second PE.

The device may perform processing for the specific ANN model in parallel through the fused PE (910). Processing for the specific model may include controlling the data network through a control signal from a controller of the first PE. A control transfer path for the control signal may be set differently from a data transfer path of the data network.

As an example, the device may include the first PE including a first operation unit and a first controller for controlling the first operation unit, and the second PE including a second operation unit and a second controller for controlling the second operation unit. The first PE and the second PE may be reconfigured into one fused PE for parallel processing for a specific ANN model. In the fused PE, operators included in the first operation unit and operators included in the second operation unit may form a data network controlled by the first controller. A control signal transmitted from the first controller may arrive at each operator through a control transfer path different from a data transfer path of the data network.

The data transfer path may have a linear structure, and the control transfer path may have a tree structure.

The control transfer path may have a lower latency than the data transfer path.

In the fused PE, the second controller may be disabled.

In the fused PE, the output of the last operator of the first operation unit may be applied as an input of the leading operator of the second operation unit.

In the fused PE, operators included in the first operation unit and operators included in the second operation unit may be segmented into a plurality of segments, and the control signal transmitted from the first controller may arrive at the plurality of segments in parallel.

The first PE and the second PE may perform processing on a second ANN model and a third ANN model, which are different from the specific ANN model, independently of each other.

The specific ANN model may be a pre-trained deep neural network (DNN) model.

The device may be an accelerator that performs inference based on the DNN model.

The above-described embodiments of the present invention may be implemented through various means. For example, embodiments of the present invention may be implemented by hardware, firmware, software, or a combination thereof

In the case of implementation by hardware, the method according to embodiments of the present invention may be implemented by one or more of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In the case of implementation by firmware or software, the method according to the embodiments of the present invention may be implemented in the form of a module, procedure, or function that performs the functions or operations described above. Software code may be stored in a memory unit and executed by a processor. The memory unit may be located inside or outside the processor and may transmit/receive data to/from the processor by various known means.

The detailed description of the preferred embodiments of the present invention described above has been provided to enable those skilled in the art to implement and practice the present invention. Although preferred embodiments of the present invention have been described, it will be understood by those skilled in the art that various modifications and changes can be made to the present invention without departing from the scope of the present invention. For example, those skilled in the art can use configurations described in the above-described embodiments by combining the configurations. Accordingly, the present invention is not intended to be limited to the embodiments described herein but is to be accorded the widest scope consistent with the principles and novel features disclosed herein.

The present information may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. In addition, claims that are not explicitly cited in the claims may be combined to form an embodiment or may be included as a new claim by amendment after filing.

What is claimed is:

1. A device for artificial neural network (ANN) processing, the device comprising:
a first processing element (PE) comprising a first operation unit and a first controller configured to control the first operation unit; and
a second PE comprising a second operation unit and a second controller configured to control the second operation unit,
wherein the first PE and the second PE are reconfigured into one fused PE for parallel processing for a specific ANN model,
wherein operators included in the first operation unit and operators included in the second operation unit form a data network controlled by the first controller in the fused PE, and
wherein a control signal transmitted from the first controller arrives at each operator through a control transfer path different from a data transfer path of the data network.

2. The device of claim 1, wherein the data transfer path has a linear structure and the control transfer path has a tree structure.

3. The device of claim 1, wherein the control transfer path has a lower latency than the data transfer path.

4. The device of claim 1, wherein the second controller in the fused PE is disabled in the fused PE.

5. The device of claim 1, wherein an output by a last operator of the first operation unit is applied as an input of a leading operator of the second operation unit in the fused PE.

6. The device of claim 1,
wherein the operators included in the first operation unit and the operators included in the second operation unit are segmented into a plurality of segments in the fused PE, and
wherein the control signal transmitted from the first controller arrives at the plurality of segments in parallel.

7. The device of claim 1, wherein the first PE and the second PE perform processing on a second ANN model and a third ANN model different from the specific ANN model independently of each other.

8. The device of claim 1,
wherein the specific ANN model is a pre-trained deep neural network (DNN) model, and
wherein the device is an accelerator configured to perform inference based on the DNN model.

9. A method of artificial neural network (ANN) processing, the method comprising:
reconfiguring a first processing element (PE) and a second PE into one fused PE for processing for a specific ANN model; and
performing processing for the specific ANN model in parallel through the fused PE,
wherein the reconstructing the first PE and the second PE into the fused PE comprises forming a data network through operators included in the first PE and operators included in the second PE,
wherein the processing for the specific model comprises controlling a data network through a control signal from a controller of the first PE, and
wherein a control transfer path for the control signal is set to be different from a data transfer path of the data network.

10. The method of claim 9, wherein the data transfer path has a linear structure and the control transfer path has a tree structure.

11. The method of claim 9, wherein the control transfer path has a lower latency than the data transfer path.

12. A processor-readable recording medium storing instructions for performing the method according to claim 9.
